(19) United States
(12) Patent Application Publication
(10) Pub. No.: US 2018/0071688 A1
(43) Pub. Date: Mar. 15, 2018

(54) SPACER FOR MEMBRANE SEPARATION

(71) Applicants: Christopher James ZWETTLER, Stillwater, MN (US); Conwed Plastics LLC, Minneapolis, MN (US)

(72) Inventors: Alexander James Kidwell, Maple Grove, MN (US); Christopher James Zwettler, Stillwater, MN (US)

(21) Appl. No.: 15/553,079

(22) PCT Filed: Feb. 23, 2016
(86) PCT No.: PCT/US2016/019089

§ 371 Date: Aug. 23, 2017

Related U.S. Application Data
(60) Provisional application No. 62/119,795, filed on Feb. 23, 2015.

(51) Int. Cl. B01D 63/10; B01D 61/02

(52) U.S. Cl. CPC B01D 63/10; B01D 2313/143; B01D 61/025

(57) ABSTRACT

Embodiments disclosed herein include a feed spacer for membrane separation system, comprising: a plurality of nodes, wherein the nodes are tapered in the direction of flow through the membrane separation system, and a plurality of strands, wherein at least one strand connects each node to another node. In an embodiment, a spacer for membrane separation system, comprises a plurality of nodes, wherein each node comprises an upstream portion and a downstream portion, and a plurality of strands, wherein at least two strands are connected to the downstream portion of each of the plurality of nodes, and the two strands connected to a downstream portion of a node are non-linear and define an arc that is concaved in the direction of the flow. Other embodiments are also included herein.

### PRIORITY

This application is being filed as a PCT International Patent application on Feb. 23, 2016 in the name of Conwed Plastics LLC, a U.S. national corporation, applicant for the designation of all countries and Alexander James Kidwell, a U.S. Citizen; inventor for all designated states; and Christopher James Zwettler, a U.S. Citizen, applicant and inventor for all designated states, and claims priority to U.S. Patent Application No. 62/119,795, filed Feb. 23, 2015, the contents of which are herein incorporated by reference in its entirety.

### FIELD OF THE TECHNOLOGY

The present application relates to a feed spacer. More specifically, the present application relates to a feed spacer for spiral wound elements used for a pressure driven membrane separation process. These pressure driven membrane separation processes include microfiltration, ultrafiltration, nanofiltration and reverse osmosis.

### BACKGROUND

Membrane separation is commonly employed to extract pure or drinkable water from salt water and brackish water. Spiral wound elements are used that employ osmotic filtration membranes. Frequently spiral wound elements can result in large pressure gradients across them. The membranes are separated by a feed spacer net that can keep the membranes at a prescribed separation distance. The feed spacer also allows tangential flow of the pressurized input water between adjacent filtration membranes.

A spacer net that produces a minimal drop in pressure as water flows through it and it resists accumulation of mineral and organic deposits can be desired. The spacer can also impart minimum deformation into the membrane surface during use and during assembly of the element.

### SUMMARY

Embodiments disclosed herein include a spacer for membrane separation systems, the spacer comprising a plurality of nodes, wherein the nodes are tapered in the direction of flow through the membrane separation system; and a plurality of strands, wherein at least one strand connects each node to another node.

In an embodiment, the plurality of nodes comprises perimeter nodes and internal nodes.

In an embodiment, the internal nodes are connected to four nodes by four different strands.

In an embodiment, each node comprises an upstream portion and a downstream portion.

In an embodiment, a top portion of each node is substantially planar.

In an embodiment, a bottom portion of each node is substantially planar.

In an embodiment, a top portion and bottom portion of each node are substantially planar.

In an embodiment, the surfaces on the top portion and bottom portion of each node are parallel.

In an embodiment, two strands are connected to the downstream portion.

In an embodiment, the two strands that are connected to the downstream portion form an arc that is concaved in the direction of the flow.

In an embodiment, the plurality of nodes is arranged in rows and columns.

In an embodiment, each of the internal nodes is directly connected by at least one strand to each of the four nearest nodes that are not in the same row or column.

In an embodiment, the feed spacer is monolithic.

In an embodiment, the upstream portion of each of the internal nodes is directly connected to the downstream portion of two nodes.

In an embodiment, the downstream portion of each of the internal nodes is directly connected to the upstream portion of two nodes.

In an embodiment, the upstream portion of each of the internal nodes is directly connected to the downstream portion of two nodes; and the downstream portion of each of the internal nodes is directly connected to the upstream portion of two nodes.

In an embodiment, the feed spacer defines a plurality of apertures.

In an embodiment, an aperture is defined by at least four strands and at least two nodes.

In an embodiment, an aperture has only one line of symmetry.

In an embodiment, a feed spacer for membrane separation system comprises: a plurality of nodes connected by a plurality of strands, wherein each node comprises a planar top surface and a planar bottom surface; and the top surface is parallel to the bottom surface.

In an embodiment, a feed spacer for membrane separation system comprises: a plurality of nodes, wherein each node comprises an upstream portion and a downstream portion, and a plurality of strands, wherein at least two strands are connected to the downstream portion of each of the plurality of nodes, and the two strands connected to a downstream portion of a node are non-linear and define an arc that is concaved in the direction of the flow.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present application is defined by the appended claims and their legal equivalents.

### BRIEF DESCRIPTION OF THE FIGURES

The technology may be more completely understood in connection with the following drawings, in which:

FIG. 1 is a top view of a feed spacer, according to an embodiment.

FIG. 2 is an enlarged top view of a portion of the spacer shown in FIG. 1, according to an embodiment.

FIG. 3 is a side view of a portion of a feed spacer, according to an embodiment.

FIG. 4 is a top view of a node, according to an embodiment.

FIG. 5 is a side view of a node, according to an embodiment.

FIG. 6 is a chart showing the modeling of pressure drop across two different feed spacers, according to an embodiment.

FIG. 7 is a chart showing the modeling of pressure drop across two different feed spacers, according to an embodiment.

FIG. 8 is chart showing the modeling of velocities across two different feed spacers, according to an embodiment.

FIG. 9 is chart showing the modeling of velocities across two different feed spacers, according to an embodiment.

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION

Membrane separation is a water purification technology that can be used to desalinate salt water or produce clean water from brackish water. Membrane separation systems can have an input of salt water or brackish water and output of pure water or substantially pure water. Membrane separation system can also have an output of salty water or other contaminants that were included in the input but removed from the pure water output.

A membrane separation system, according to various embodiments, can include an input, an assembly, a first output and a second output. As discussed above, the input can include salt water or brackish water. In other embodiments, the input can include a liquid that will be separated into a pure liquid and contaminants. The assembly can separate the contaminants from the pure liquid. In an embodiment, the assembly can separate salt from water. The assembly can include layers of a membrane separated by a feed spacer. The membrane can be semipermeable. In various embodiments, the feed spacer can include a polymer such as a thermoplastic, a thermoset plastic, or an elastomer. In various embodiments, the polymer can include one or more of nylon, polyethylene, or polystyrene. In various embodiments, the feed spacer can be injection molded, such that in various embodiments, the feed spacer can include a polymer that is able to be injection molded.

The system can have two outputs, a first output and a second output. The first output can include pure water or substantially pure water. The first output can be substantially pure water, such that it is safe for human consumption or can be considered potable water. The first output can be substantially free of contaminants, such as the contaminants that are a portion of the second output. The second output can include contaminants, such as salt or bacteria. The second output can be separated from the first output, such as within the assembly.

The assembly can include a feed spacer and a membrane. In various embodiments, the assembly can include a plurality of feed spacers and a plurality of membranes. The assembly can include a feed spacer between two adjacent membranes, such that the assembly can include alternating membranes and feed spacers. The flow can be generally tangential to the feed spacers and the membranes, such that the flow goes across the feed spacers and membranes and in some cases the flow can go through a feed spacer and/or a membrane.

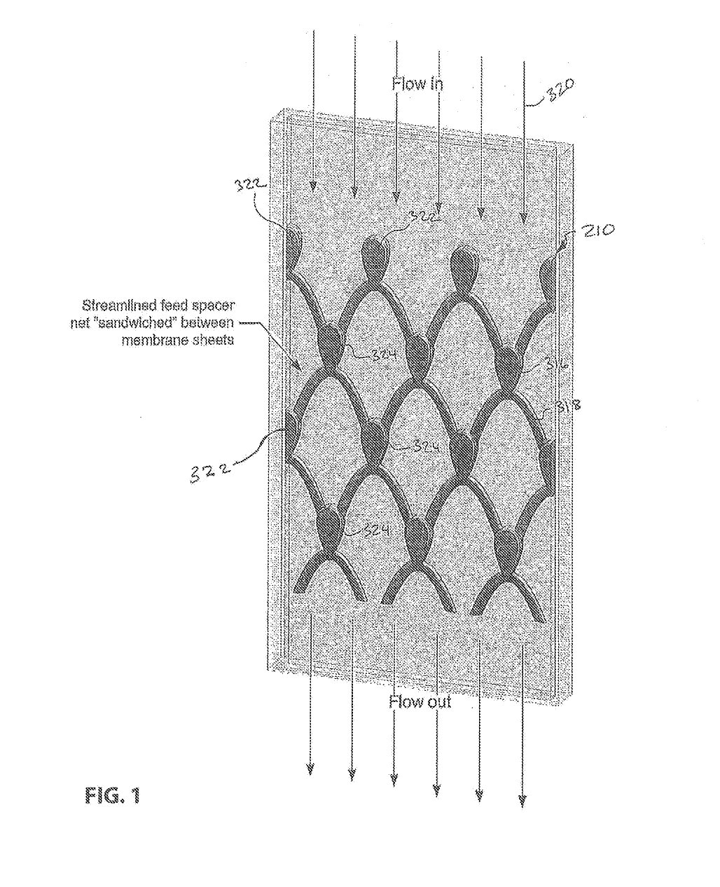

As will be discussed in FIGS. 1-5, the feed spacer 210 can include a plurality of nodes and a plurality of strands. In various embodiments, the nodes can be substantially similar, such as having the same shape and size. In some embodiments, each node can have a top surface, such as a flat or planar surface. The top surface can contact a membrane. In some embodiments, each node can have a bottom surface, such as a flat or planar surface. The bottom surface can contact a membrane. In various embodiments, the top surface and the bottom surface can be parallel.

The height of each node can be the distance from the top surface to the bottom surface. In various embodiments, the height of the nodes defines the distance between each membrane.

FIG. 1 shows a top view of a feed spacer 210, according to an embodiment. In various embodiments, the feed spacer 210 can be monolithic, such as when the feed spacer 210 is injection molded. The feed spacer 210 can be monolithic, such that the feed spacer 210 is formed as a single piece of material, such as a single piece of polymer.

The feed spacer 210 can include a plurality of nodes 316 and a plurality of strands 318. At least one strand can be connected to each node. At least one strand can connect each node 316 to at least one other node 316. In some embodiments, the majority of the nodes 316 are connected to at least four strands 318. In various embodiments, each strand 318 can be connected to two nodes 316. The flow across the feed spacer can be represented by arrow 320.

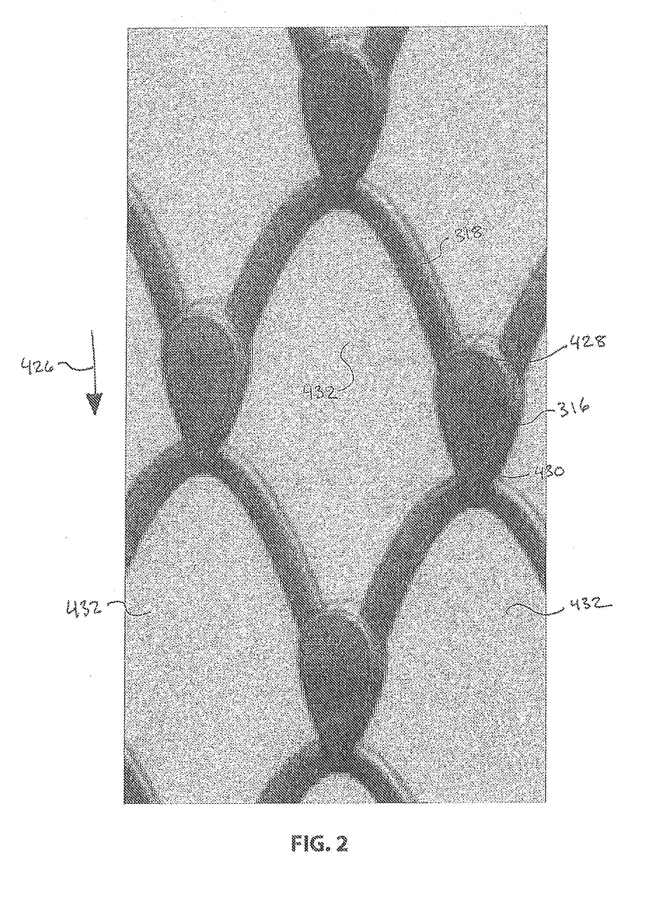

As will be discussed in FIGS. 2-5, each node 316 can be tapered in the direction of flow across the feed spacer 210. Each node 316 can be tapered, such that the upstream portion of the node is thicker or wider than a downstream portion of the node. In an embodiment, the downstream portion of node can be the thinnest or least wide portion of the node 316. In an embodiment, the downstream portion of the node 316 can come to a point.

In various embodiments, the nodes 316 can be arranged into rows and columns within the feed spacer 210. In some embodiments, the rows can be staggered, such as every other row is aligned, such as the first row, the third row and the fifth row are all aligned together, and the second row, the fourth row and the sixth row are all aligned together (as shown in FIG. 1). In some embodiments, each row can be offset from the previous row or the following row by half of the distance between each node 316 in the row, such that nodes in second row are aligned with the halfway point between nodes in the first row and/or the third row.

In some embodiments, the columns can be staggered, such as every other column is aligned, such as the first column, the third column and the fifth column are all aligned together, and the second column, the fourth column and the sixth column are all aligned together (as shown in FIG. 1). In some embodiments, each column can be offset from the previous column or the following column by half of the distance between each node 316 in the column, such that nodes in second column are aligned with the halfway point between nodes in the first column and/or the third column.

In an embodiment, each row of nodes 316 can be separated by about 0.25 inches, such as the distance between nodes is about 0.25 inches. In an embodiment, each row of nodes 316 can be separated by about 0.25 inches, such as the distance between the centers of two nodes in adjacent rows is about 0.25 inches.

In an embodiment, each row of nodes 316 can be separated by at least 0.125 inches and not more than 0.375 inches. In an embodiment, each row of nodes 316 can be separated by at least 0.2 inches and not more than 0.3 inches.

In an embodiment, each column of nodes 316 can be separated by about 0.25 inches, such as the distance between nodes is about 0.25 inches. In an embodiment, each column of nodes 316 can be separated by about 0.25 inches, such as the distance between the centers of two nodes in adjacent columns is about 0.25 inches.

In an embodiment, each column of nodes 316 can be separated by at least 0.125 inches and not more than 0.375 inches. In an embodiment, each column of nodes 316 can be separated by at least 0.2 inches and not more than 0.3 inches.

Strands 318 can link together nodes 316. Strands can extend from one node 316 to another node 316. In some embodiments, the strands 318 can have a circular cross-section. In some embodiments, the strands 318 can have an oval cross-section. In some embodiments, the strands 318 can have a rectangular or square cross-section. In various embodiments, a strand 318 can link a downstream portion of a node 316 to an upstream portion of an adjacent node 316. The strands 318 can have a thickness of about half of the thickness of a node 316. In an embodiment, the strands 318 can have a thickness of at least 40% the thickness of a node 316 and not more than 60% the thickness of a node 316. In an embodiment, the strands 318 can have a thickness of at least 25% the thickness of a node 316 and not more than 75% the thickness of a node 316.

In some embodiments, the plurality of nodes 316 can include perimeter nodes 322 and internal nodes 324. Perimeter nodes 322 can refer to nodes 316 located around the perimeter of the feed spacer 210. In some embodiments, one or more of the perimeter nodes 322 can be coupled to a single strand 318 or two strands 318. The perimeter nodes 322 can be coupled to fewer strands 318 that link the node to an adjacent node, because, in various embodiments, the perimeter nodes 322 do not have nodes in each direction, since the perimeter nodes 322 is located around the perimeter of the nodes 316 of the feed spacer 210.

In various embodiments, each internal node 324 can be directly connected to four strands 318. In various embodiments, each of the four strands connected to an internal node 324 can couple the internal node 324 to four adjacent nodes 316. The four adjacent nodes 316 can include one or more perimeter nodes 322 and/or one or more internal nodes 324. In an embodiment, each internal node 324 is connected to four adjacent nodes 316 by four different strands 318. In an embodiment, each of the internal nodes 324 is directly connected by at least one strand 318 to each of the four nearest nodes 316 that are not in the same row or column.

FIG. 2 shows a top view of a portion of a feed spacer 210, according to an embodiment. The direction of flow across the feed spacer 210 is represented by arrow 426.

Each node 316 can include an upstream portion 428 and a downstream portion 430. The node 316 can taper from the upstream portion 428 to the downstream portion 430. In an embodiment, the node 316 can have a tear drop shape.

In various embodiments, two strands 318 can be connected to the downstream portion 430 of each node 316. In various embodiments, two strands 318 can be connected to the upstream portion 428 of each node 316.

In some embodiments, the two strands 316 that are connected to the downstream portion 430 can form an arc, such as an arc that is concaved in the direction of the flow. The arc can be concaved downstream, such as shown in FIG. 2.

The strands 318 can have one end connected to the upstream portion 428 of a node 316 and the opposite end connected to the downstream portion 430 of a different node 316. In an embodiment, every internal node 324 can have two strands 318 from its upstream portion 428, each strand 318 extending to a different downstream portion 430 of an adjacent node 318. In an embodiment, every internal node 324 can have two strands 318 from its downstream portion 430, each strand 318 extending to a different upstream portion 428 of an adjacent node 318.

The feed spacer 210 can define a plurality of apertures 432. In various embodiments, each aperture 432 can be defined by at least a portion of four strands 318 and at least a portion of two nodes 316. In various embodiments, each aperture 432 can be defined by at least a portion of four strands 318 and at least a portion of four nodes 316.

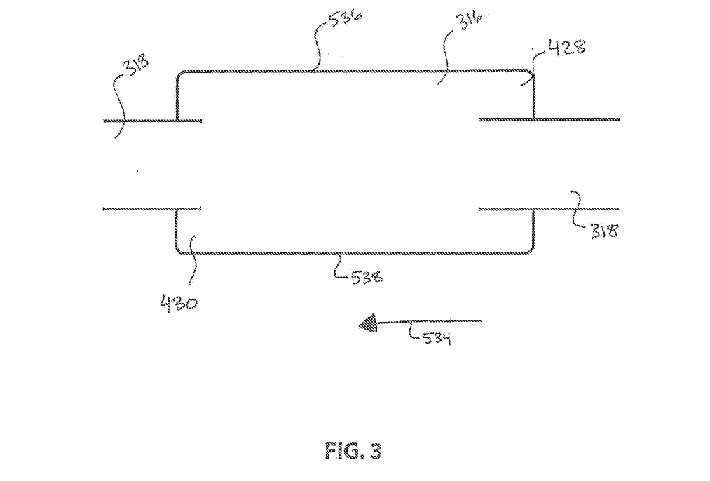

FIG. 3 shows a side view of a portion of a feed spacer 210, according to an embodiment. The direction of flow across the feed spacer 210 is represented by arrow 534. In an embodiment, the node 316 can include a top surface 536 and a bottom surface 538.

In various embodiments, the strands 318 can extend from an approximate mid-point between the top surface 536 and the bottom surface 538, such as shown in FIG. 3. In an embodiment, the top surface of the strands 318 can be aligned with the top surface 536. In an embodiment, the bottom portion of the strands 318 can be aligned with the bottom surface 538.

FIG. 4 shows a top view of a node 318, according to an embodiment. The direction of flow past the node 316 is represented by arrow 640. The node 316 can be tapered in the direction of flow. The perimeter of the top of the node 316 can include non-linear segments. The perimeter of the top of the node 316 can be tear drop shaped.

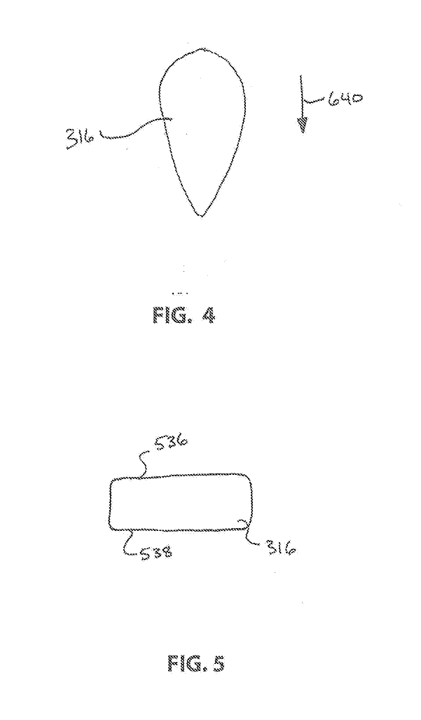

FIG. 5 shows a side view of a node 316, according to an embodiment. The top surface 536 of the node 316 can be planar or flat. The bottom surface 538 of the node 316 can be planar or flat. The top surface 536 can be parallel with the bottom surface 538.

The embodiments of the present technology described herein are not intended to be exhaustive or to limit the technology to the precise forms disclosed in the following detailed description. Rather, the embodiments are chosen and described so that others skilled in the art can appreciate and understand the principles and practices of the present technology.

All publications and patents mentioned herein are hereby incorporated by reference. The publications and patents disclosed herein are provided solely for their disclosure. Nothing herein is to be construed as an admission that the inventors are not entitled to antedate any publication and/or patent, including any publication and/or patent cited herein.

### Results of Modeling

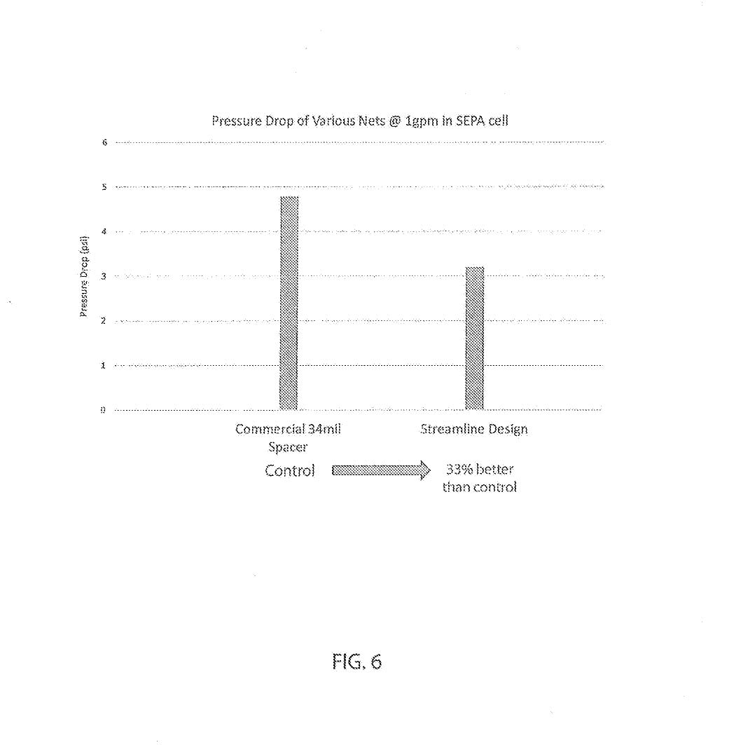

FIGS. 6 to 9 show the results of modeling. The modeling shows the calculated pressure drops and velocities across different spacers. In each of the models a control spacer was used. The control spacer was a commercial 34 mil blue spacer. In each of the models a spacer as described herein was used, referred to as a streamline spacer.

In general, it can be advantageous to have lower pressure drops across the feed spacer. FIG. 6 shows a chart depicting the results of modeling pressure drop across the two feed spacers. The streamline feed spacer has approximately a 33% less pressure drop over the feed spacer as compared to the commercial feed spacer.

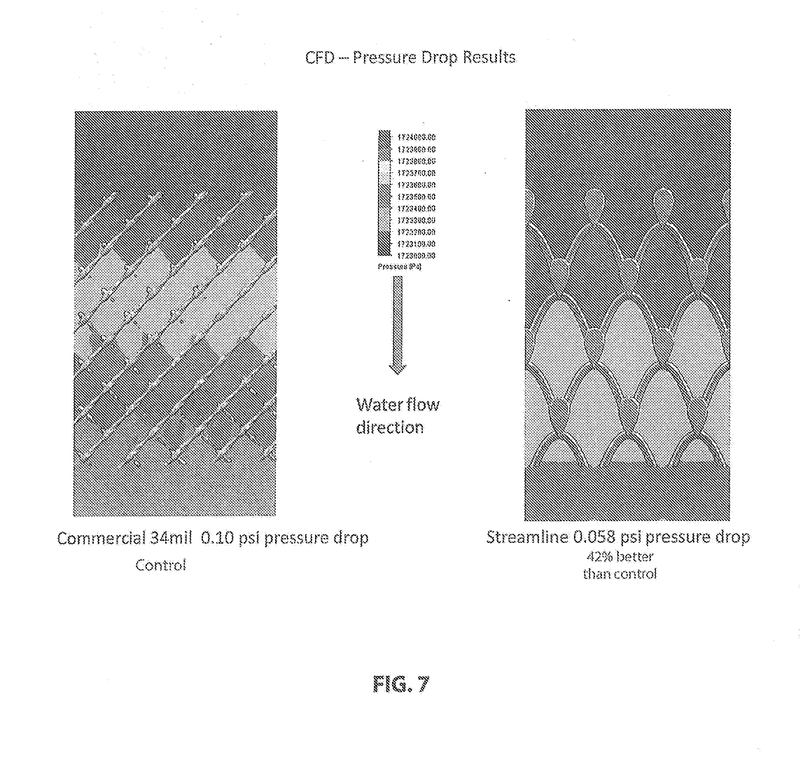

FIG. 7 shows the pressure drop modeling across the two different feed spacers. FIG. 7 shows the pressures at different locations across the feed spacers. The commercial feed spacer had a 0.10 psi pressure drop. The streamline feed spacer had a 0.058 psi pressure drop, a 42% smaller pressure drop compared to the commercial feed spacer. Further, it is evident from the model shown in FIG. 7, that the feed spacer has higher or equal pressure values than the commercial feed spacer at the majority of locations on the feed spacer.

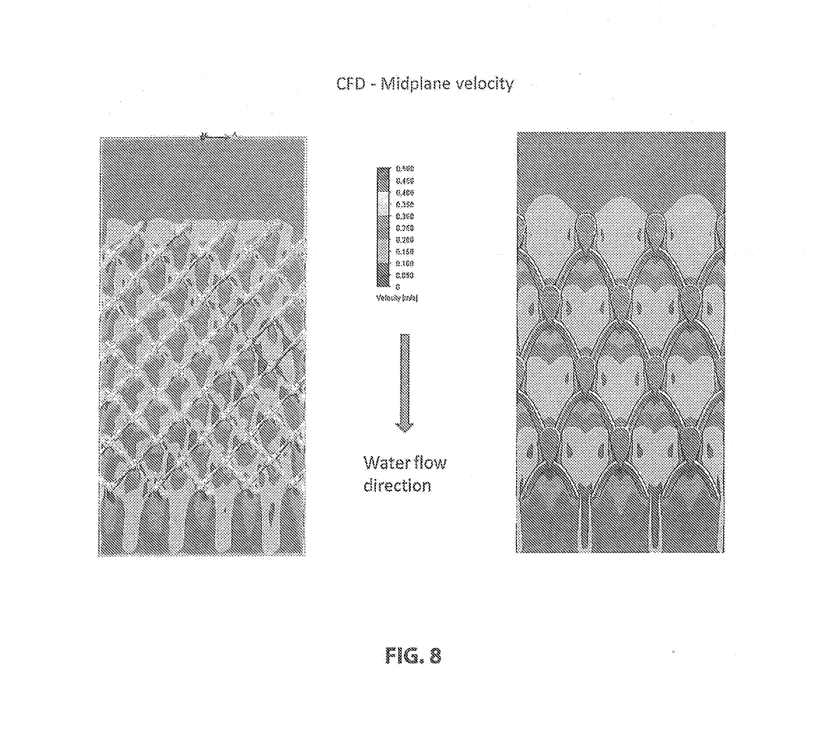

In general it can be advantageous to have higher velocities across the feed spacer. FIG. 8 shows the velocity modeling across two different feed spacers. As shown in FIG. 8, the streamlined feed spacer has considerably more locations where the velocity is between 0.300 m/s and 0.450 m/s. The commercial feed spacer has considerably more locations where the velocity is between 0.100 m/s and 0.300 m/s.

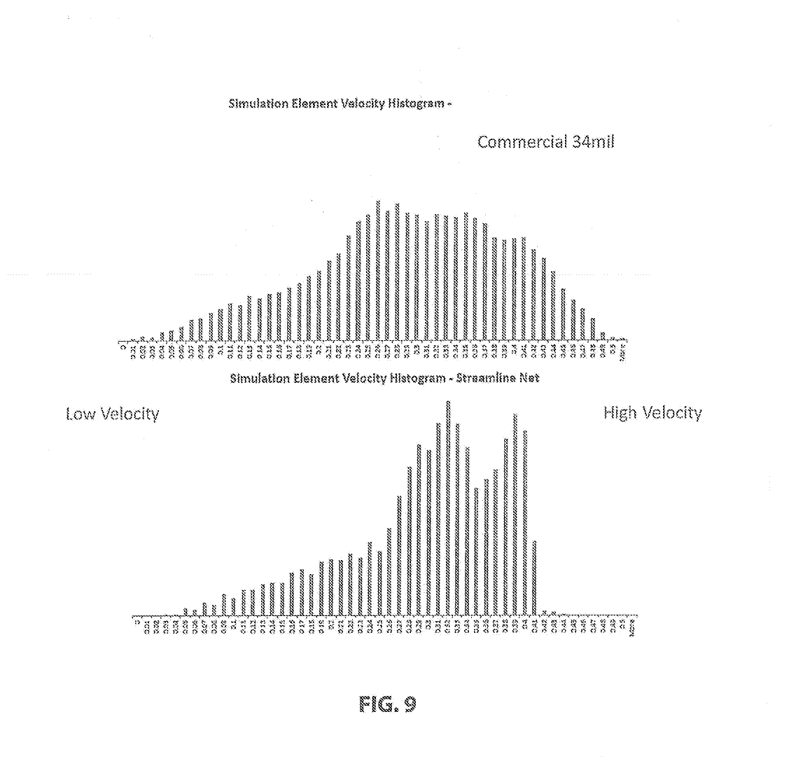

FIG. 9 shows a histogram of the velocities across the commercial feed spacer and the streamline feed spacer. Similar to FIG. 8, the streamlined feed spacer has considerably more locations where the velocity is between 0.300 m/s and 0.450 m/s and the commercial feed spacer has considerably more locations where the velocity is between 0.100 m/s and 0.300 m/s. The streamline feed spacer has more locations within the desired range of velocities compared to the commercial feed spacer.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration to. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference.

The technology has been described with reference to various specific and preferred embodiments and techniques. However, it should be understood that many variations and modifications may be made while remaining within the spirit and scope of the technology.

1. A feed spacer a spirally wound element used in a membrane separation process such as a reverse osmosis system, the feed spacer comprising:
a plurality of nodes, wherein the nodes are tapered in the direction of flow through the membrane separation system, and
a plurality of strands, wherein at least one strand connects each node to another node.

2. The feed spacer for membrane separation according to any of claims 1 and 3-20, wherein the plurality of nodes comprises perimeter nodes and internal nodes.

3. The feed spacer for membrane separation according to any of claims 1-2 and 4-20, wherein the internal nodes are connected to four nodes by four different strands.

4. The feed spacer for membrane separation according to any of claims 1-3 and 5-20, wherein each node comprises an upstream portion and a downstream portion.

5. The feed spacer for membrane separation according to any of claims 1-4 and 6-20, wherein a top portion of each node is planar.

6. The feed spacer for membrane separation according to any of claims 1-5 and 7-20, wherein a bottom portion of each node is planar.

7. The feed spacer for membrane separation according to any of claims 1-6 and 8-20, wherein a top portion and bottom portion of each node are planar.

8. The feed spacer for membrane separation according to any of claims 1-7 and 9-20, wherein the top portion and bottom portion of each node are parallel.

9. The feed spacer for membrane separation according to any of claims 1-8 and 10-20, wherein two strands are connected to the downstream portion

10. The feed spacer for membrane separation according to any of claims 1-9 and 11-20, wherein the two strands that are connected to the downstream portion form an arc that is concaved in the direction of the flow.

11. The feed spacer for membrane separation according to any of claims 1-10 and 12-20, wherein the plurality of nodes is arranged in rows and columns.

12. The feed spacer for membrane separation according to any of claims 1-11 and 13-20, wherein the plurality of nodes is arranged in rows and columns.

13. The feed spacer for membrane separation according to any of claims 1-12 and 14-20, wherein each of the internal nodes is directly connected by at least one strand to each of the four nearest nodes that are not in the same row or column.

14. The feed spacer of any of claims 1-13 and 15-20, wherein the feed spacer is monolithic.

15. The feed spacer for membrane separation according to any of claims 1-14 and 16-20, wherein the upstream portion of each of the internal nodes is directly connected to the downstream portion of two nodes.

16. The feed spacer for membrane separation according to any of claims 1-15 and 17-20, wherein the downstream portion of each of the internal nodes is directly connected to the upstream portion of two nodes.

17. The feed spacer for membrane separation according to any of claims 1-16 and 18-20, wherein the upstream portion of each of the internal nodes is directly connected to the downstream portion of two nodes; and
wherein the downstream portion of each of the internal nodes is directly connected to the upstream portion of two nodes.

18. The feed spacer for membrane separation according to any of claims 1-17 and 19-20, wherein the feed spacer defines a plurality of apertures.

19. The feed spacer for membrane separation according to any of claims 1-18 and 20, wherein an aperture is defined by at least four strands and at least two nodes.

20. The feed spacer for membrane separation according to any of claims 1-19, wherein an aperture has only one line of symmetry.

21. A feed spacer a spirally wound element used in a membrane separation process such as a reverse osmosis system, comprising:
a plurality of nodes connected by a plurality of strands, wherein each node comprises a planar top surface and a planar bottom surface; and
top surface is parallel to the bottom surface.

22. A feed spacer a spirally wound element used in a membrane separation process such as a reverse osmosis system, comprising:
a plurality of nodes, wherein each node comprises an upstream portion and a downstream portion, and
a plurality of strands, wherein at least two strands are connected to the downstream portion of each of the plurality of nodes, and the two strands connected to a downstream portion of a node are non-linear and define an arc that is concaved in the direction of the flow.
